(19) United States
(12) Patent Application Publication
(10) Pub. No.: US 2026/0150177 A1
(43) Pub. Date: May 28, 2026

(54) ION SOURCE

(71) Applicant: NISSIN ION EQUIPMENT CO., LTD., Koka-city (JP)

(72) Inventors: Shinkichi HAMADA, Koka-city (JP); Yuta IWANAMI, Koka-city (JP); Hiroto NAKAMURA, Koka-city (JP)

(73) Assignee: NISSIN ION EQUIPMENT CO., LTD., Koka-city (JP)

(21) Appl. No.: 19/260,904

(22) Filed: Jul. 7, 2025

(30) Foreign Application Priority Data
Nov. 27, 2024 (JP) 2024-205878

(51) Int. Cl. H05H 1/48

(52) U.S. Cl. CPC H05H 1/48

(57) ABSTRACT

An ion source includes a vaporizer that includes a crucible that is long in a longitudinal direction and a nozzle connected to the crucible at a connecting portion of the crucible, a plasma generation chamber to which gas is supplied from the crucible through the nozzle, and a controller that controls a temperature of the vaporizer. The controller controls the temperature of the vaporizer in response to a temperature of the plasma generation chamber or in response to a parameter correlated with the temperature of the plasma generation chamber so that a temperature of the connecting portion is higher than a temperature of a central portion of the crucible in the longitudinal direction.

### CROSS REFERENCE TO RELATED APPLICATIONS

This application is based on and claims priority from Japanese Patent Application No. JP 2024-205878 filed on Nov. 27, 2024 in the Japan Patent Office, the contents of which being incorporated by reference herein in its entirety.

### BACKGROUND

### 1. Field

The present disclosure relates to an ion source.

### 2. Description of Related Art

Silicon carbide (SiC) devices are expected to be used in high-voltage and high-temperature applications such as electric vehicles, railways and power plants, and are featured as one of the items to realize a low-carbon society. The manufacturing process for SiC devices is similar to that of silicon devices in that both use an ion implantation process.

In the ion implantation process for SiC devices, nitrogen or phosphorus ions are implanted as an N-type dopant and aluminum or boron ions are implanted as a P-type dopant into a SiC wafer in the production of a PN junction.

### SUMMARY

According to an aspect of one or more embodiments, there is provided an ion source comprising a vaporizer that includes a crucible that is long in a longitudinal direction and a nozzle connected to the crucible at a connecting portion of the crucible; a plasma generation chamber to which gas is supplied from the crucible through the nozzle; and a controller configured to control a temperature of the vaporizer. The controller controls the temperature of the vaporizer in response to a temperature of the plasma generation chamber or in response to a parameter correlated with the temperature of the plasma generation chamber so that a temperature of the connecting portion is higher than a temperature of a central portion of the crucible in the longitudinal direction.

According to another aspect of one or more embodiments, there is provided an ion source comprising a plasma generation chamber; a vaporizer comprising a crucible, the vaporizer being configured to supply a gas from the crucible to the plasma generation chamber through a nozzle provided at a distal end of the crucible; and a controller configured to control a temperature of the vaporizer. The controller controls the temperature of the vaporizer so that a temperature at a distal end portion of the crucible is higher than a temperature at a central portion of the crucible.

### BRIEF DESCRIPTION OF THE DRAWINGS

The above and/or other aspects will become apparent and more readily appreciated from the following description of various embodiments, taken in conjunction with the accompanying drawings, in which:

FIG. 1 illustrates an example of an ion source, according to some embodiments;

FIG. 2 illustrates an example of an ion source, according to some embodiments;

FIG. 3 illustrates a simplified electrical configuration diagram of the ion sources in FIG. 1 and FIG. 2, according to some embodiments;

FIG. 4 illustrates a flow-chart regarding an example of temperature control of a vaporizer, according to some embodiments;

FIG. 5 illustrates a flow-chart regarding an example of temperature control of a vaporizer, according to some embodiments;

FIG. 6 illustrates an example of an ion source according to some embodiments;

FIG. 7 illustrates a flow-chart regarding an example of temperature control of a vaporizer, according to some embodiments.

### DETAILED DESCRIPTION

In all the drawings for explaining the various embodiments, common components are denoted by the same reference numerals, and repeated description thereof will be omitted for conciseness. The following embodiments do not unduly limit the contents of the present disclosure described in the appended claims. Further, all the components shown in the embodiments are not necessarily essential components of the present disclosure. Each drawing is a schematic view and is not necessarily intended to illustrate various dimensions strictly.

In the generation of nitrogen ions, phosphorus ions, and boron ions, a plasma is generally generated using a gas as a raw material. However, there is no optimum gas as a raw material to produce aluminum ions.

Sputtering of aluminum-containing solid materials (such as aluminum nitride, alumina, etc.) has been used to generate the plasma containing aluminum ions. Further, a method using a vaporizer is also used. Specifically, a solid material containing aluminum is placed in a crucible, and the crucible is heated to generate a vapor containing aluminum from the solid material. The plasma containing aluminum ions is generated from the generated vapor.

In contrast to such a related art vaporizer, a new vaporizer has been proposed, and is described in U.S. patent application Ser. No. 17/714,491, filed Apr. 6, 2022, now U.S. Pat. No. 12,112,915 for “VAPORIZER, ION SOURCE AND METHOD FOR GENERATING ALUMINUM-CONTAINING VAPOR” and/or U.S. patent application Ser. No. 18/948,063, filed Nov. 14, 2024, published as U.S. Patent Application Publication No. 2025/0071881 for “VAPORIZER, ION SOURCE AND METHOD FOR GENERATING ALUMINUM-CONTAINING VAPOR” and/or U.S. patent application Ser. No. 17/945,705, filed Sep. 15, 2022, published as U.S. Patent Application Publication No. 2024/0098869 for “VAPORIZER, ION SOURCE AND METHOD FOR GENERATING ALUMINUM-CONTAINING VAPOR”, the entire contents of each of these U.S. patent applications being herein incorporated by reference in their entireties.

In the new vaporizer, a reactive gas (e.g., chlorine gas, hydrogen chloride gas, or the like) is supplied to a crucible. A solid material (e.g., pure aluminum, aluminum nitride, alumina, etc.) is placed in the crucible. In the crucible, a reactive gas reacts with the solid material to produce a reaction product (e.g., aluminum chloride) on the solid material. The reaction product is vaporized by heating the crucible, and the vaporized reaction product is supplied to a plasma generation chamber. In the plasma generation chamber, a plasma containing aluminum ions is generated based on the supplied vapor.

In order to improve an efficiency of aluminum ion generation, it is advantageous to increase the crucible temperature. When the crucible temperature is increased, the amount of chlorine radicals generated due to a chlorine component in the reactive gas increases. Chlorine radicals readily bond with aluminum. As a result, the amount of AlCl produced increases.

A long cylindrical crucible for a large solid material is advantageous to increase a lifetime of the vaporizer. In such a long crucible, a temperature distribution exists in the longitudinal direction of the crucible. The temperature distribution tends to be such that the temperature is higher at a center of the crucible where a heater is disposed, and the temperature is lower at the end of the crucible than at the center of the crucible.

When AlCl that is produced in the central portion of the crucible at a relatively high temperature reaches the end portion of the crucible at a relatively low temperature by a flow of the reactive gas supplied into the crucible in the longitudinal direction of the crucible, AlCl is separated into Al and Cl due to the influence of the temperature difference.

The crucible and a nozzle fixed to the end of the crucible are made of a carbon material in terms of heat resistance, processability, cost, and the like.

When AlCl is separated, Cl is discharged as a gas. By contrast, the separated Al remains in the crucible end portion in an active state, and the separated Al reacts with the crucible and the nozzle, which as discussed above, is made of a carbon material, to generate Al₄C₃.

In the crucible heated to a high temperature, aluminum is liquefied. The wettability of the liquefied aluminum is improved by mixing Al₄C3 in the liquefied aluminum.

When the wettability of the liquefied aluminum is improved, there may be a disadvantage that melted aluminum creeps up to the inlet of the nozzle that discharges the vapor into the plasma generation chamber, and causes clogging of the nozzle. Various embodiments may address these disadvantages.

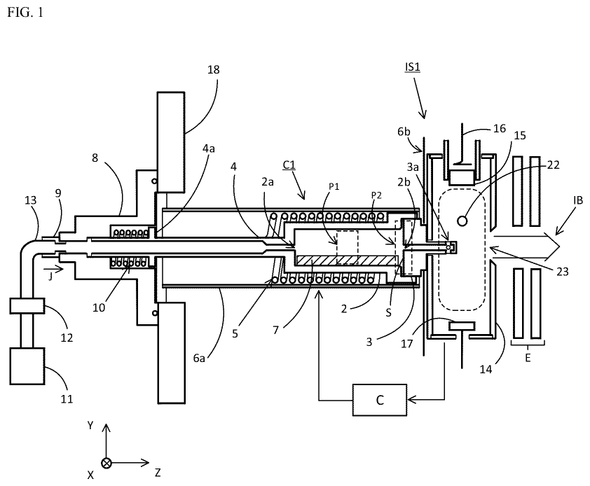

FIG. 1 is a schematic cross-sectional view of an ion source IS, according to an embodiment. In the embodiment, the ion source IS may be an indirectly heated cathode (IHC) ion source. In an embodiment, the ion source IS may include a vaporizer C1, a filament 16, a cathode 15, a plasma generation chamber 14 and a repeller electrode 17. In the ion source IS, the filament 16 heats the cathode 15. The heated cathode 15 emits ionizing electrons into the plasma generation chamber 14. The repeller electrode 17 is disposed opposite to the cathode 15. The repeller electrode 17 repels the ionizing electrons approaching the repeller electrode 17 toward the cathode 15.

An electromagnet (not shown) is disposed outside the plasma generation chamber 14. The electromagnet generates a magnetic field along the direction in which the cathode 15 and the repeller electrode 17 face each other inside the plasma generation chamber 14.

A vapor containing aluminum is supplied from the vaporizer C1 to the plasma generation chamber 14. In the plasma generation chamber 14, a plasma (indicated by the broken line) is generated from the vapor. The ion beam IB containing aluminum ions is extracted from the ion extraction port 23 of the plasma generation chamber 14 by an extraction electrode E.

FIG. 1 shows an example of the extraction electrodes E having two electrodes. Each electrode has a passage hole for the ion beam IB. However, the number of electrodes constituting the extraction electrode E shown in FIG. 1 is merely an example. In some embodiments, the number of electrodes constituting the extraction electrode E may be three or more, and may be changed according to the configuration of the ion source.

The vaporizer C1 may include a crucible 2 configured to receive with an aluminum-containing solid material 7 (for example, pure aluminum, aluminum nitride, or aluminum oxide), a first nozzle 3, a second nozzle 4, and a heater 5. The solid material 7 may include a powder.

The crucible 2 illustrated in FIG. 1 may be a cylindrical member elongated in one direction. For example, the axis of the crucible 2 may extend along a Z-axis direction, as illustrated in FIG. 1. The crucible 2 has an outlet 2b and an inlet 2a in the Z-axis direction. The outlet 2b is configured to supply the vapor to the plasma generation chamber 14. The inlet 2a is configured to receive a chlorine-containing gas as a reactive gas to the crucible 2 is provided.

The chlorine-containing gas may be a gas containing a chloride ingredient such as a chloride gas (Cl₂) or a hydrochloride gas (HCl).

A first nozzle 3 may be detachably attached to the crucible 2. In an embodiment, as illustrated in FIG. 1, the second nozzle 4 for supplying the reactive gas into the crucible 2 may be formed integrally with the crucible 2. As a method of attaching the first nozzle 3 to the crucible 2, various methods (for example, fitting and/or screwing) can be used.

In an embodiment, the first nozzle 3, the second nozzle 4, and the crucible 2 may be made of a carbon material in terms of heat resistance, processability, cost, and the like.

In FIG. 1, an arrow J indicates the flow of the chlorine-containing gas supplied to the crucible 2. The chlorine-containing gas flows from a gas supply source 11 through a valve 12 in a pipe 13, the second nozzle 4, the crucible 2, and the first nozzle 3 in this order, and flows into the plasma generation chamber 14.

When the chlorine-containing gas flows into the crucible 2, the chlorine-containing gas reacts with the aluminum-containing solid material 7 heated to a high temperature. This reaction produces a reaction product such as aluminum chloride (AlCl₃).

The reaction product thus produced is vaporized in the crucible 2 at a high temperature, whereby the vapor containing aluminum particles are produced. The vapor and the chlorine-containing gas are supplied from the crucible 2 to the plasma generation chamber 14 through the first nozzle 3.

In some embodiments, the aluminum-containing solid material 7 may be pure aluminum with a purity of 99.90% or more. Pure aluminum increases the proportion of aluminum in the vapor relative to other materials. By using such pure aluminum, the ion beam current of the ion beam IB containing aluminum ions extracted from the ion source IS increases.

However, the aluminum-containing solid material 7 is not limited to pure aluminum. In some embodiments, aluminum nitride, aluminum oxide, and/or other aluminum-containing solid materials may be used.

The chlorine-containing gas may be supplied to the second nozzle 4 through a connection member 9 fitted into the second nozzle 4. Further, a mass flow controller may be connected to the pipe 13 connecting the gas supply source 11 and the connection member 9 to control the flow rate of the chlorine-containing gas. However, a specific configuration for supplying the gas is not particularly limited as long as the chlorine-containing gas can be supplied to the connection member 9.

In an embodiment, the first nozzle 3 may include an end 3a opposite to an end of the first nozzle 3 that is attached to the crucible 2. In an embodiment, the end 3a may protrude into the plasma generation chamber 14. The end 3a is provided with vapor supply holes in four directions orthogonal to each other. With this configuration, the vapor can be diffused and supplied in multiple directions inside the plasma generation chamber 14. However, the number of the vapor supply holes formed in the end 3a is not limited to four. In some embodiments, the number of vapor supply holes may be less than four or more than four.

The heater 5 may be disposed on the outer periphery of the crucible 2. The heater 5 may be, for example, a coil heater or a sheet heater. However, various heaters other than these may be used. In an embodiment, a first heat shield plate 6a for blocking heat radiation from the heater 5 may be disposed on the outer periphery of the heater 5. Similarly, in an embodiment, in order to avoid heat transmission from the plasma generation chamber 14 to the crucible 2, a second heat shield plate 6b may be disposed between the plasma generation chamber 14 and the first nozzle 3.

The second nozzle 4 may have a large-diameter portion 4a. A flange 8 may be provided for attaching the vaporizer C1 to the source flange 18.

In FIG. 1, the ion source flange 18 indirectly supports the plasma generation chamber 14 and other components such as the filament 16 and the cathode 15 around the plasma generation chamber 14 by supporting components (not shown).

In some embodiment, a coil spring 10 may be provided between the flange 8 and the large-diameter portion 4a of the second nozzle 4. The coil spring 10 may be an elastic member that biases the vaporizer C1 against the side wall of the plasma generation chamber 14 and keeps the space between the first nozzle 3 and the plasma generation chamber 14 airtight, in order to prevent the inflow of the vapor and/or the chlorine-containing gas from between the members.

The elastic member for urging the vaporizer C1 against the side wall of the plasma generation chamber 14 is not limited to the coil spring 10, and other alternative structures such as a plate spring may be used.

In an embodiment, in order to keep the space between the first nozzle 3 and the plasma generation chamber 14 airtight, one or more gaskets (not shown) may be provided between the vaporizer C1 and the side wall of the plasma generation chamber 14.

In order to avoid excessive pressure due to the elastic force of the coil spring 10, a damper, for example, a spring clip in the form of a snap ring may be attached to the first nozzle 3. Similarly, in order to prevent an excessive force due to the elasticity of the coil spring 10, a damper (for example, a spring clip) may be provided between the large-diameter portion 4a of the second nozzle 4 and the first heat shield plate 6a.

In some embodiments, the aluminum-containing solid material 7 may have a semicircular cross section in an XY plane. Since the chlorine-containing gas flows along the surface of the aluminum-containing solid material 7, the chlorine-containing gas and the solid material 7 can be efficiently reacted.

Ion species other than aluminum ions are also used to create PN junctions in SiC devices. When the other ion species are generated, a gas such as PH₃, PF₃, BF₃, or N₂ is supplied to the plasma generation chamber 14. In an embodiment, a supply path of such a gas may be shared with the flow path of the chlorine-containing gas.

However, since a disadvantage such as unexpected discharge may occur due to mixing with the residual gas, in some embodiments, a gas supply path for the other ion species may be separately provided from the flow path of the chlorine-containing gas.

In an embodiment, as illustrated in FIG. 1, a gas inlet 22 for supplying another gas species is provided in the wall surface of the plasma generation chamber 14 on the X-axis side.

The IHC ion source shown in FIG. 1 is an example. As the ion source, other configurations such as a Bernas type and a radio-frequency type may be adopted.

Instead of projecting the end 3a of the first nozzle 3 into the plasma generation chamber 14, in some embodiments, the tip of the end 3a provided in the first nozzle 3 may be flush with the wall of the plasma generation chamber 14. In this case, the number of vapor supply holes formed in the end 3a of the first nozzle 3 may be one in the Z direction.

When the crucible 2 is heated to a high temperature, a large amount of chlorine radicals may be generated from the chlorine-containing gas. Chlorine radicals readily combine with aluminum to form AlCl.

When AlCl produced at the center of the crucible 2 at a relatively high temperature reaches the end of the crucible 2 at a relatively low temperature by the flow of the reactive gas supplied to the crucible 2 in the longitudinal direction of the crucible 2, AlCl is separated into Al and Cl due to the influence of the temperature difference. The center of the crucible 2 at a relatively high temperature is a center portion P1 as shown in FIG. 1. The end of the crucible 2 at a relatively low temperature is a connecting portion P2 as shown in FIG. 1.

When AlCl is separated, Cl is discharged as a gas. On the other hand, the separated Al remains at the end of the crucible 2 in an active state, and the separated Al reacts with the carbon crucible 2 and the first nozzle 3 to produce Al₄C₃.

When the crucible 2 is heated to a high temperature, aluminum is liquefied. The Al₄C₃ mixed in the aluminum may improve the wettability of the liquefied aluminum. The aluminum with improved wettability may travel through the crucible and may ultimately reach the vicinity of the first nozzle 3.

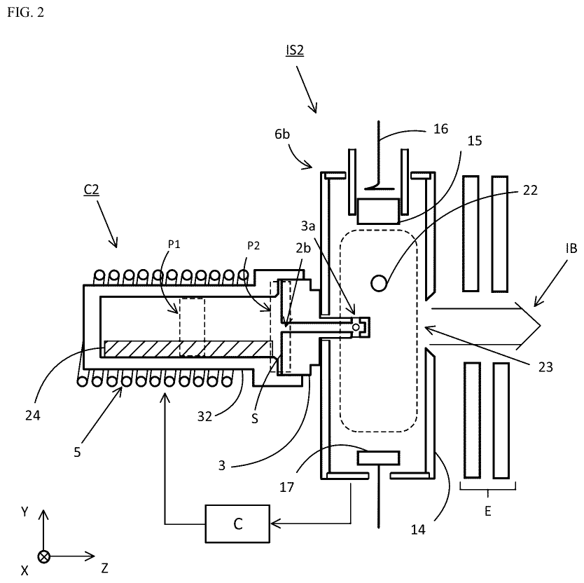

The aluminum with improved wettability adheres to a first surface S of the first nozzle 3 in FIG. 2. The first surface S forms a side wall of the crucible 2 on the side of the plasma generation chamber 14. The amount of aluminum deposited on the first surface S increases with time, and the aluminum flows into the passage T of the first nozzle 3 at a certain timing. As a result, clogging of the first nozzle 3 may be caused.

Since the temperature of the connecting portion P2 between the crucible 2 and the first nozzle 3 may be lower than the temperature of the central portion P1 of the crucible 2, there may be a disadvantage that melting aluminum may precipitate at the connecting portion P2. As the result, precipitated aluminum may cause clogging of the first nozzle 3.

As a countermeasure against such clogging, the temperature at the crucible end portion, which is the connecting portion P2 between the first nozzle 3 and the crucible 2, may be set higher than the temperature at the central portion P1 in the longitudinal direction (Z-axis direction) of the crucible 2.

During the operation of the ion source IS1, the generation of Al₄C₃ can be suppressed by setting the temperatures of the central portion P1 and the connecting portion P2 of the crucible 2 to the above-described relationship. As a result, the wettability of the aluminum liquefied in the crucible 2 is not improved, and it becomes difficult for the liquefied aluminum to reach the vicinity of the first nozzle 3, and lifetime of the vaporizer C1 may thus be improved.

The ion source IS1 is provided with a controller C in order to make the temperature of the connecting portion P2 higher than the temperature of the central portion P1 of the crucible 2.

The controller C includes an arithmetic processing unit and a storage. The arithmetic processing unit may be, for example, a microprocessor, a central processing unit, a microcontroller, or hardware control logic, or a combination thereof. The arithmetic processing unit may be provided as a plurality of arithmetic processing units. The storage may include various storage memories such as ROM, RAM, a solid state device (SSD), or other memory. The storage may store program codes for realizing various functions such as data-storing functions, data-computing functions, control functions for controlling the respective parts of the ion source IS1 based on computation results, and control functions for controlling the respective parts of the ion source IS1 based on input date, and reference values used for comparison processing described later. The arithmetic processing unit of the controller C accesses the program code and the reference values stored in the storage of the controller C and executes the program code to cause the controller C to perform each function described herein.

During the operation of the ion source IS1, the temperature of the plasma generation chamber 14 or a parameter correlated with the temperature of the plasma generation chamber 14 is input as input data to the controller C.

The controller C compares the reference value stored in the storage with the input data, and the controller C changes the setting temperature of the vaporizer C1 according to the comparison result. The temperature of the vaporizer C1 is determined by the output of the heater 5 of the crucible 2.

The temperature of the plasma generation chamber 14 changes according to the operation conditions of the ion source IS1. For example, when the beam current of the ion beam IB extracted from the ion source IS1 is large, the temperature of the plasma generation chamber 14 becomes relatively high. On the other hand, when the beam current of the ion beam IB extracted from the ion source IS1 is low, the temperature of the plasma generation chamber 14 becomes relatively low.

Since the first nozzle 3 is disposed in the vicinity of the plasma generation chamber 14, the first nozzle 3 is affected by a temperature change of the plasma generation chamber 14. When the temperature of the vaporizer C1 is constant, the temperature of the connecting portion P2 is changed via the first nozzle 3 by changing the temperature of the plasma generation chamber 14. On the other hand, the central portion P1 of the crucible 2 is minimally affected by the temperature change of the plasma generation chamber 14. Therefore, the temperature of the central portion P1 of the crucible 2 is determined in consideration of the setting temperature of the vaporizer C1.

When the temperature of the plasma generation chamber 14 is relatively high, the temperature of the first nozzle 3 also becomes relatively high, and the temperature of the connecting portion P2 becomes higher than the temperature of the central portion P1 of the crucible 2. In such a temperature relationship, the wettability of liquefied aluminum in the crucible 2 is not improved, and the liquefied aluminum becomes more difficult to enter the first nozzle 3.

On the other hand, when the temperature of the plasma generation chamber 14 is relatively low, the temperature of the first nozzle 3 also becomes relatively low, and the temperature of the connecting portion P2 becomes lower than the temperature of the central portion P1 of the crucible 2. In such a temperature relationship, the wettability of the liquefied aluminum is improved, which may cause clogging of the first nozzle 3.

Therefore, in order to suppress the improvement of the wettability of the liquefied aluminum, the controller C sets the output of the heater 5 to be low so that the temperature of the connecting portion P2 is higher than the temperature of the central portion P1 of the crucible 2. This setting makes it difficult for the liquefied aluminum to reach the vicinity of the first nozzle 3, and lifetime of the vaporizer C1 may be improved.

The controller C setting the output of the heater 5 to be low means that the output of the heater 5 is lowered as compared with the output of the heater 5 when the temperature of the plasma generation chamber 14 is relatively high.

FIG. 2 is a schematic cross-sectional view of an ion source IS2, according to some embodiments. The same numerals are used for the same components as those of the ion source IS1 of FIG. 1, and repeated descriptions thereof are omitted for conciseness.

The ion source IS2 may include a vaporizer C2. The vaporizer C2 may include a crucible 32 and an aluminum-containing material 24. In the ion source IS2, the crucible 32 and the aluminum-containing material 24 are different from the configuration of the ion source IS1. The crucible 32 does not have the gas inlet 2a which the crucible 2 has. The aluminum-containing material 24 may include a liquid material such as aluminum iodide or dimethylaluminum chloride, instead of a solid material such as aluminum chloride or pure aluminum.

In the ion source IS2 shown in FIG. 2, the crucible 32 is heated by the heater 5 to vaporize the aluminum-containing material 24, and the gas containing aluminum is supplied to the plasma generation chamber 14. Even in the ion source IS2 including the vaporizer C2, there is a concern that the first nozzle 3 may be clogged due to the improvement in wettability of the liquefied aluminum, similar to the clogging in the ion source IS1.

Therefore, similarly to the ion source IS1, the ion source IS2 includes a controller C that controls the setting temperature of the crucible 32 according to the temperature of the plasma generation chamber 14 or a parameter correlated with the temperature of the plasma generation chamber 14.

By providing such a controller C, it is possible to suppress clogging of the first nozzle 3 due to improvement in wettability of the liquefied aluminum.

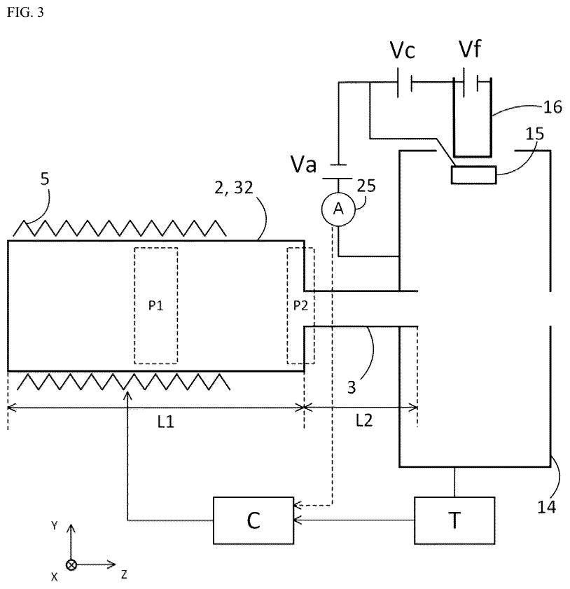

FIG. 3 shows a simplified electrical configuration diagram regarding the ion source IS1 shown in FIG. 1 and the ion source IS2 shown in FIG. 2, according to some embodiments. In FIG. 3, the gas inlet 2a of the crucible 2, the reflection electrodes 17, and the like are partially omitted to simplify the description.

During the operation of the ion source, the temperature of the plasma generation chamber 14 is measured by a thermometer T. A measurement result from the thermometer T is transmitted to the controller C. The thermometer T may be, for example, a contact thermocouple, a thermography, or a radiation thermometer.

As described above with respect to the ion source IS1, the controller C compares the temperature of the plasma generation chamber 14 with the reference value stored in the storage of the controller C. Thereafter, the controller C controls the output of the heater 5 in accordance with the comparison result. In some embodiments, the reference value of the temperature may be set experimentally. In some embodiments, the reference value of the temperature may be set during manufacturing of the ion source IS1 or IS2. In some embodiments, the reference value of the temperature may be set in advance.

The data transmitted to the controller C may be a parameter correlated with the temperature of the plasma generation chamber 14, instead of the temperature of the plasma generation chamber 14. The controller C compares the value of the parameter with the reference value for the temperature that is stored in the storage of the controller C, and the controller C controls the output of the heater 5. An example of the parameter correlated with the temperature of the plasma generation chamber 14 may be a density of the plasma generated in the plasma generation chamber 14. As the plasma density increases, the temperature of the plasma generation chamber 14 increases. On the contrary, when the plasma density decreases, the temperature of the plasma generation chamber 14 decreases.

In an embodiment, a probe for measuring the plasma density may be installed inside the plasma generation chamber 14. In some embodiments, a measuring device for measuring electromagnetic waves radiated from the generated plasma may be disposed in the vicinity of the plasma generation chamber 14.

Various power supplies may be provided around the plasma generation chamber 14. For example, in some embodiments, a filament power supply Vf may be connected between terminals of the filament 16. In some embodiments, a cathode power supply Vc may be connected between the filament 16 and the cathode 15. In some embodiments, an arc power supply Va may be connected between the plasma generation chamber 14 and the cathode 15. The value of an arc current flowing through the arc power supply Va is correlated with the density of the plasma generated in the plasma generation chamber 14, and thus the arc current is also correlated with the temperature of the plasma generation chamber 14.

In an embodiment, the arc current may be measured by an ammeter 25, and the measurement result may be transmitted to the controller C, and the controller C may control the output of the heater 5 based on the measurement result from the ammeter 25. In an embodiment, the controller C may control the output of the heater 5 in accordance with the value of an electric power which is a product of the arc current and the arc voltage.

In the case where the ion source is of a Bernas type, the cathode 15 may be omitted, and thermal electrons are directly emitted from the filament 16 into the plasma generation chamber 14. In this case, the filament 16 serves as a thermoelectron emitter that supplies thermoelectrons to the plasma generation chamber 14.

When a length of the first nozzle 3 is sufficiently longer than a length of the crucible 2 or 32 in the longitudinal direction of the crucible 2 or the crucible 32, the temperature of the central portion of the first nozzle 3 becomes low, and there is a disadvantage that the gas passing through the central portion may be deposited on the first nozzle 3.

In addition, when the length of the first nozzle 3 is sufficiently long, the first nozzle 3 may excessively inhibit heat transfer from the plasma generation chamber 14 to the crucible 2 or the crucible 32. As the result, although the plasma generation chamber 14 has a relatively high temperature, the temperature of the connecting portion P2 may be lowered.

In view of the above disadvantages, the relationship between a length L1 of the crucible 2 or the crucible 32 and a length L2 of the first nozzle 3 may be set so that the length L1 of the crucible 2 or the crucible 32 is twice or more the length L2 of the first nozzle 3 in the longitudinal direction of the crucible 2 or the crucible 32. In other words, in an embodiment, the lengths may satisfy L1>=2*L2.

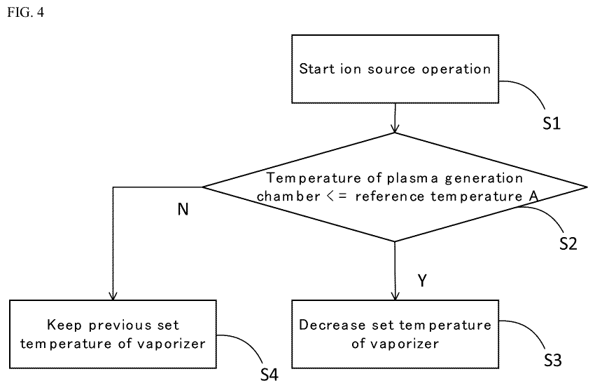

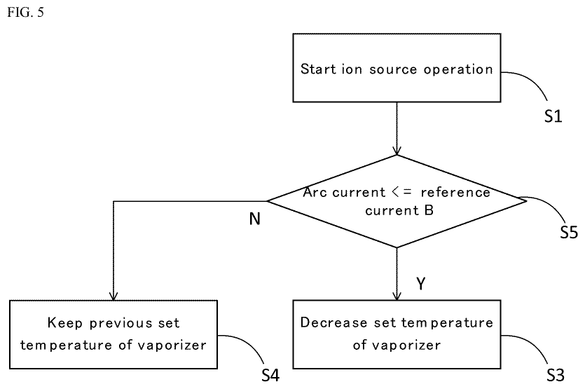

FIGS. 4 and 5 are flowcharts regarding setting a temperature control of the vaporizer C1 or the vaporizer C2, according to some embodiments. The same reference numerals are used for the same processes in the FIGS. 1-5, and repeated description thereof is omitted for conciseness. In some embodiments, the operations illustrated in the flowcharts of FIGS. 4-5 may be performed by the controller C.

The operation of the ion source is started (S1). At this time, initial values (e.g., initial setting values) determined for each operation condition of the ion source are set in the operation parameters of the respective parts of the ion source IS1 or IS2 including the output of the heater 5.

In the flowchart of FIG. 4, the temperature of the plasma generation chamber 14 is monitored during the operation of the ion source IS1 or IS2, and the temperature is compared with the reference temperature A (e.g., a temperature reference value) stored in the storage of the controller C (S2).

If the temperature of the plasma generation chamber 14 is less than or equal to the reference temperature A (S2, Y), the output of the heater 5 is decreased from the initial set value to decrease the set temperatures of the vaporizer C1 or the vaporizer C2 (S3). For example, in an embodiment, the controller C may control the output of the heater 5 to decrease the output of the heater from the initial set value. On the other hand, if the temperature of the plasma generation chamber 14 is greater than the reference temperature A (S2, N), the output of the heater 5 is not changed from the initial set value, and the previously set temperatures of the vaporizer C1 or the vaporizer C2 are maintained (S4). For example, in an embodiment, the controller C may control the output of the heater 5 to not change the output of the heater 5 from the initial set value to maintain the temperature. In some embodiments, the controller C may take no setting action to maintain the previously set temperature.

In the flowchart of FIG. 5, the arc current is monitored during the operation of the ion source IS1 or the ion source IS2, and the arc current is compared with the reference current B (e.g., an arc current reference value) stored in the storage of the controller C (S5). The same processing as the processing of the flowchart of FIG. 4 is performed except that the comparison target in the controller C is different. In other words, if the arc current is less than or equal to the reference current B (operation S5, Y), the set temperature is decreased. If the arc current is greater than the reference current B (operation S5, N), the set temperature is not changed and the previously set temperature of the vaporizer C1 or the vaporizer C2 is maintained.

In the flowcharts of FIGS. 4 and 5, after the operation of the ion source IS1 or the ion source IS2 is started, the respective parameters are actually measured after the operation of the ion source IS1 or the ion source IS2 is stabilized, and the comparison processing in the controller C is performed.

However, unlike the flowcharts of FIGS. 4 and 5, the comparison determination process in each flowchart may be performed by inferring the values of the target parameters (the temperature of the plasma generation chamber 14, the arc current, the plasma concentration, or the like) from the operation conditions set at the time of the start of the operation before the start of the operation of the ion source IS1 or the ion source IS2. Then, at the time of starting the operation of the ion source IS1 or the ion source IS2, the vaporizer C1 or the vaporizer C2 is operated at an appropriate set temperature. Such a series of processes is performed by the controller C.

For example, the relationship between the operating conditions and the target parameters during the operation of the ion source is stored in the storage of the controller C, and the relationship is read from the storage after the operating conditions are determined, and the vaporizer C1 or the vaporizer C2 is operated at the appropriate set temperature.

There is a disadvantage in that, with the passage of time after the operation of the ion source, even when the ion source is operated under the same operation condition, a difference may occur in the value of the target parameter, the target parameter may fluctuate during the operation of the ion source, and the like.

As a countermeasure to address such a disadvantage, the control of the set temperatures of the vaporizer C1 or the vaporizer C2 by the controller C may be performed both before the start of the operation of the ion source and after the start of the operation of the ion source.

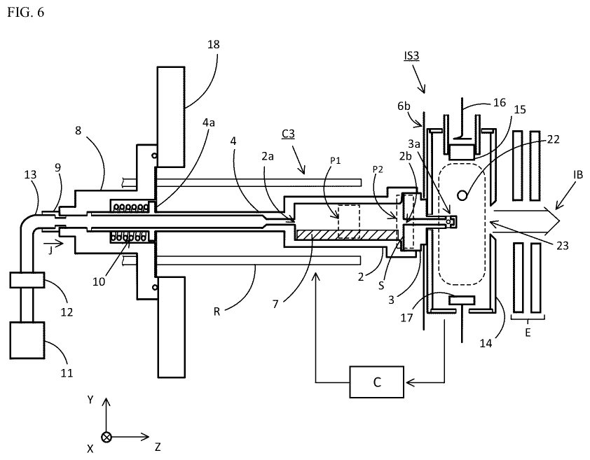

FIG. 6 is a schematic sectional view of an ion source IS3, according to an embodiment. The difference from the ion source IS1 of FIG. 1 is in the method of generating the gas containing aluminum from the aluminum-containing solid material 7. In a vaporizer C3 of the ion source IS3, heat generated when the reactive gas (e.g., a chlorine-containing gas) introduced into the crucible 2 and the aluminum-containing solid material 7 chemically react with each other may be used to vaporize aluminum chloride as a reactive product. Thus, in some embodiments, the heater may be omitted from the vaporizer C3.

In some embodiments, unlike the embodiment illustrated in FIG. 6, in order to promote the reaction between the reactive gas and the solid material 7, a heater 5 may be provided and used as in the case of the vaporizer C1 or the vaporizer C2.

The set temperature in the vaporizer C3 may be changed by cooling the crucible 2 using a cooling member R. In an embodiment, the cooling member R may be a right cylindrical member, and may be disposed around the crucible 2. In some embodiment, the cooling member R may not physically contact the crucible 2. In an embodiment, the cooling member R may cover a range of the crucible 2 corresponding to the central portion P1 of the crucible 2 on the outer periphery of the crucible 2, as illustrated in FIG. 6.

In some embodiments, as a specific example of the cooling member R, a water-cooled chiller or an air-cooled chiller may be used.

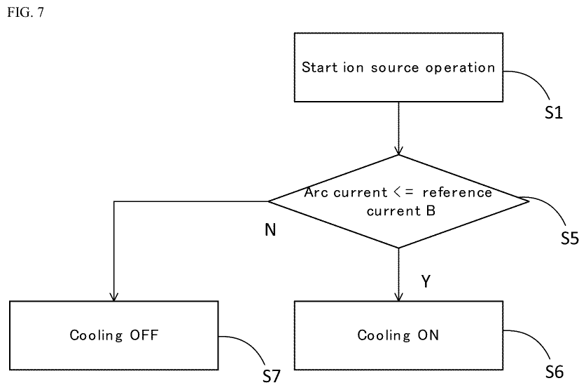

FIG. 7 is a flowchart of setting a temperature control in the vaporizer C3, according to an embodiment. In FIG. 7, the same reference numerals are used as in FIGS. 4 and 5. In some embodiments, the operations illustrated in FIG. 7 may be performed by the controller C.

The operation of the ion source is started (S1). At this time, initial setting values determined for each operation condition are set in the operation parameters of the respective parts of the ion source IS3 including the output of the heater 5.

The flowchart of FIG. 7 is based on the premise that the function of the cooling member R is stopped at the time of the initial operation of the ion source IS3. Further, during the operation of the ion source IS3, the flow rate of the reactive gas is constant.

During the operation of the ion source IS3, the value of the arc current is monitored and compared with the reference current B (e.g., an arc current reference value) stored in the storage of the controller C (S5).

If the arc current value is less than or equal to the reference current B (operation S5, Y), the cooling member R is operated to lower the setting temperature of the vaporizer C3 (S6). On the other hand, if the value of the arc current is greater than the reference current B (operation S5, N), the function of the cooling member R is stopped and the setting temperature of the vaporizer C3 is maintained (S7).

The flowchart of FIG. 7 illustrates a process performed after the operation of the ion source IS3 is started. However, as described in the embodiments of the flowcharts of FIGS. 4 and 5, the controller C may perform the setting temperature control of the vaporizer IS3 before the operation start of the ion source IS3 or before and after the operation start of the IS3 of the ion source C3.

In the flowcharts of FIGS. 4, 5, and 7, a configuration in which one reference value and one measurement value are compared is shown, but a plurality of reference values and measurement values may be compared.

For example, in an embodiment, a plurality of reference values may be provided in a stepwise manner, and the output of the heater 5 may be changed in a stepwise manner in accordance with the number of reference values.

Further, the controller C may perform the setting temperature control of the vaporizer C1, C2, or C3 by comparing a plurality of parameters with reference values. Specifically, in an embodiment, two parameters of the temperature of the plasma generation chamber 14 and the arc current may be compared with the respective reference values, and when both comparison results are less than or equal to the reference values, the output of the heater 5 is reduced by a predetermined amount.

Further, the reference value stored in the storage of the controller C may be updated to change the reference value according to the use state of the ion source IS1, IS2, or IS3.

In the above embodiments, the explanation is made on the assumption that the initial setting temperature of the vaporizer C1, C2, or C3 is a high temperature. Under this assumption, for example, the flowchart of FIG. 4 describes that the output of the heater 5 is reduced if the temperature of the plasma generation chamber 14 is less than or equal to a reference value.

However, in some embodiments, the initial setting temperature of the vaporizer C1, C2, or C3 may be set to a low temperature. In this case, the process performed after the comparison determination process between the reference value and the target parameter is different from the process described in the flowcharts of FIGS. 4, 5, and 7. That is, in this case, the process is the opposite as the process described in the flowcharts of FIGS. 4, 5, and 7.

Specifically, in the flowcharts of FIGS. 4 and 5, when the condition is satisfied in the comparison determination process, the process of not changing the output of the heater 5 and maintaining the temperature is performed. On the contrary, when the condition is not satisfied in the comparison determination process, the process of increasing the output of the heater 5 is performed.

The cooling member R described in the flowchart of FIG. 7 is not a means for increasing the temperature of the vaporizer C3. Therefore, in some embodiments, the heater 5 may be separately attached to the ion source IS3, and as described as the modified example of the flowcharts of FIGS. 4 and 5, when the condition is satisfied in the comparison determination process, a process of not changing the output of the heater 5 is performed. On the contrary, when the condition is not satisfied in the comparison determination process, a process of increasing the output of the heater 5 is performed.

The output of the heater 5 may be reduced when the condition is satisfied in the comparison determination process between the target parameter and the reference value in the ion source IS1 or the ion source IS2. However, in some embodiments, the cooling member R described in FIG. 6 may be provided in the ion source IS1 or the ion source IS2, and the cooling member R may be made to function to lower the temperature of the vaporizer C1 or the vaporizer C2.

Further, although a non-contact type configuration is exemplified as the cooling member R, in some embodiments, a cooling member R that physically contacts the crucible 2 may be adopted.

It should be understood that embodiments are not limited to the various embodiments described above, but various other changes and modifications may be made therein without departing from the spirit and scope thereof as set forth in appended claims.

What is claimed is:

1. An ion source comprising:
a vaporizer that includes a crucible that is long in a longitudinal direction and a nozzle connected to the crucible at a connecting portion of the crucible;
a plasma generation chamber to which gas is supplied from the crucible through the nozzle; and
a controller configured to control a temperature of the vaporizer;
wherein the controller controls the temperature of the vaporizer in response to a temperature of the plasma generation chamber or in response to a parameter correlated with the temperature of the plasma generation chamber so that a temperature of the connecting portion is higher than a temperature of a central portion of the crucible in the longitudinal direction.

2. The ion source according to Claim1, wherein the vaporizer further comprises a heater configured to heat the crucible;
wherein the controller controls the temperature of the vaporizer by controlling an output of the heater.

3. The ion source according to claim 2, wherein the controller decreases the output of the heater, in response to the temperature of the plasma generation chamber or the parameter correlated with the temperature of the plasma generation chamber being less than or equal to a reference value.

4. The ion source according to claim 1, wherein the crucible includes a gas inlet through which a reactive gas is introduced into the crucible, and
wherein the crucible is configured to receive a solid material.

5. The ion source of claim 4, wherein the reactive gas is a chlorine-containing gas.

6. The ion source of claim 4, wherein the solid material is an aluminum-containing solid material.

7. The ion source according to claim 4, wherein the controller controls the temperature of the vaporizer by controlling a flow rate of the reactive gas.

8. The ion source according to claim 4, wherein the vaporizer further comprises a heater configured to heat the crucible, and
wherein the controller controls the temperature of the vaporizer by controlling an output of the heater.

9. The ion source according to claim 4, wherein the vaporizer includes a chiller that covers the central portion of the crucible in the longitudinal direction of the crucible.

10. The ion source according to claim 9, wherein the chiller is a cylindrical member.

11. The ion source according to claim 1, further comprising:
a filament or a cathode configured to emit thermal electrons into the plasma generation chamber; and
an arc power supply configured to apply a voltage between the plasma generation chamber and the filament or the cathode;
wherein the parameter is an arc current flowing through the arc power supply.

12. The ion source according to claim 1, wherein the parameter is a density of plasma generated in the plasma generation chamber.

13. The ion source according to claim 1, wherein the nozzle contains a carbon material.

14. The ion source of claim 1, wherein the crucible is configured to receive a liquid or solid material containing a halogen.

15. The ion source according to claim 1, wherein a length of the crucible in the longitudinal direction is twice or more a length of the nozzle in the longitudinal direction.

16. An ion source comprising:
a plasma generation chamber;
a vaporizer comprising a crucible, the vaporizer being configured to supply a gas from the crucible to the plasma generation chamber through a nozzle provided at a distal end of the crucible; and
a controller configured to control a temperature of the vaporizer;
wherein the controller controls the temperature of the vaporizer so that a temperature at a distal end portion of the crucible is higher than a temperature at a central portion of the crucible.
